(19) United States
(12) Patent Application Publication
(10) Pub. No.: US 2004/0042946 A1
(43) Pub. Date: Mar. 4, 2004

(54) Method and installation for purifying cement plant fumes

(76) Inventor: Gilles Vicard, Lyon (FR)

Correspondence Address: DOWELL & DOWELL PC, SUITE 309, 1215 JEFFERSON DAVIS HIGHWAY, ARLINGTON, VA, 22202

(21) Appl. No.: 10/433,367

(22) PCT Filed: Dec. 3, 2001
(86) PCT No.: PCT/FR01/03811

(30) Foreign Application Priority Data
Dec. 4, 2000 (FR) 00/15697

(51) Int. Cl. B01D 46/24

(52) U.S. Cl. 423/215.5

(57) ABSTRACT

The invention concerns a method which consists: in extracting (through 18) fumes to be purified outside the furnace (2), at a temperature ranging between 250 and 400° C.; directing the extracted fumes towards a cyclone-type dust-suppressing unit (24); evacuating (through 26) through a first outlet of the dust-suppressing unit, the fumes cleaned of dust, which are denitrified (in 28); evacuating (through 30) through a second outlet of the dust-suppressing unit, a marginal fraction of fumes, ranging between 1 and 6% of the fumes input into the dust suppressing unit, said marginal fraction being collected simultaneously with the dust; and mixing (in 36) the denitrified fumes and said marginal fraction of fumes.

The present invention relates to a method and an installation for purifying cement plant fumes.

Cement, in particular Portland cement, is widely used in sectors as varied as bridges and highways, the construction or production of large pipings. Several varieties of cements and several methods for manufacture thereof are used, each having its particular specificities.

The method for manufacturing cement begins by the preparation of a mixture made from raw materials such as clay, limestone, lime. These elements contribute the silicon, calcium, aluminium and iron which are the essential elements in a cement.

These different elements are then ground either by wet method or by dry method. Such grinding can generate an enormous quantity of dust and it is necessary to resort to devices for treating the fumes, such as bag filters, cyclone dust catchers or sometimes electrofilters.

In a subsequent key step, the ground material, dry or wet, is calcined in furnaces, where the product is taken to a maximum temperature of about 1450° C. Several types of furnaces exist and the furnaces of the “LEPOL” type can be mentioned in particular, as well as the long rotary furnaces. Pre-heaters are often employed.

In the course of this method, the supplied mixture undergoes a chemical transformation and gives rise to clinker. However, the attrition and continual stirring of these solids generate a considerable quantity of dust. Furthermore, the effluent gases emerging from the furnaces are usually also much laden with such dust. Certain intermediate flows may consequently contain concentrations of dust exceeding 100 g/Nm³ of fumes.

Several methods and approaches are used, with a view to removing the dust from these fumes. Cyclone dust catchers and electrofilters can recover this dust, which is either returned into the furnace or sometimes purely and simply eliminated. Bag filters are also employed.

However, the fact of taking to a temperature exceeding 1000° C. a product in an atmosphere containing oxygen and nitrogen, also generates nitrogen oxides, as in a process of combustion. The pressure inherent to the emission standards in force, or anticipated, leads to carrying out a treatment to reduce the total quantity of these pollutants rejected during the implementation of cement manufacturing methods.

Several solutions are potentially available and certain of them are used commercially.

A selective, non-catalytic method for reducing the nitrogen oxides may be used (SNCR). In such a method, a reducing agent, such as ammonia NH₃ or urea NH₂—CO—NH₂, is injected and reacts with the oxides to transform them into nitrogen. Although this method makes it possible to reduce the nitrogen oxides by 50 to 70%, it imposes particular servitudes and cannot always be put into operation.

In effect, in order to be efficient, the reagent, namely ammonia or urea, must be introduced within a narrow temperature range. The latter, which is included between 950 and 1150° C., is not always accessible. In addition, these methods generate a certain quantity of nitrogen protoxide N₂O, a gas with a pronounced greenhouse effect. U.S. Pat. No. 5,137,704 presents an improved variant of this technology.

Another known method consists in using burners of a particular type, called “low NOₓ” burners. However, the reduction of the NO and NO₂ contents is limited, and the quality of the clinker obtained may be decreased by the use of these burners, due to the alteration of the speciation of the sulphur.

Methods using bundles of electrons have been proposed in other industries, but these devices are too expensive for the cement making industry.

Finally, a so-called SCR (Selective Catalytical Reduction) method has already been used. This method allows a reduction of more than 90% of the nitrogen oxides and consists in passing the gases to be treated, to which a reagent such as ammonia has been added, over a catalytic bed, containing for example vanadium and tungsten oxides.

However, the catalyst used is sensitive to the dust and must be protected. If a filter is used, the temperature must generally be lowered to below 200° C. Now, the majority of catalysts must work above 250° C. The exchangers which are called upon represent additional equipment and therefore corresponding investments.

The cyclones which are also used have too low a yield to be able to guarantee a dust content compatible both with the input contents imposed by the method and those necessary for a reliable and economic use of the SCR catalysts. The latter must have a life of several years and must therefore be protected.

The present invention aims at proposing a method for purifying cement plant fumes making it possible to overcome the different drawbacks set forth hereinabove.

To that end, it has for its object a method for purifying cement plant fumes in which the fumes to be purified circulate in a furnace comprising a drying chamber and a calcination chamber, characterized in that it comprises the following steps:

extracting the fumes to be purified out of the furnace, these extracted fumes being at a temperature included between 250 and 400° C.;

directing the extracted fumes towards a cyclone-type dust suppressing unit;

evacuating through a first outlet of the dust suppressing unit the fumes cleaned of dust, which are denitified;

evacuating through a second outlet of the dust suppressing unit a marginal fraction of the fumes, included between 1 and 6% of the fumes input into the dust suppressing unit, this marginal fraction being collected at the same time as the dust; and

mixing the denitrified fumes and said marginal fraction of fumes.

According to other characteristics of the invention:

the extracted fumes are at a temperature included between 280 and 350° C.;

the marginal fraction of fumes is included between 2 and 4%, particularly 3%, of the fumes input into the dust suppressing unit;

the denitrified fumes are returned into the drying chamber, these denitrified fumes are extracted out of the furnace, then these denitrified fumes extracted from the furnace are mixed with said marginal fraction;

the mixture of denitrified fumes and of said marginal fraction is directed towards an additional dust suppressor;

the denitrified fumes and the marginal fraction are mixed, then the mixture of denitrified fumes and of said marginal fraction is directed towards the drying chamber of the furnace.

The invention also has for its object an installation for purifying cement plant fumes, comprising a furnace belonging to a cement manufacturing installation, this furnace comprising a drying chamber and a calcination chamber in which the fumes to be purified circulate, in service, characterized in that it comprises:

means for extracting the fumes to be purified out of the furnace, these extraction means extending from an intermediate zone of said furnace having, in service, a temperature included between 250 and 400° C., preferably between 280 and 350° C.;

a dust suppressing unit, placed in communication with the extraction means;

first evacuation means, making it possible to extract from the dust suppressing unit the fumes cleaned of dust;

second evacuation means, making it possible to extract from the dust suppressing unit a marginal fraction of the fumes admitted into this unit, this marginal fraction being collected at the same time as dust;

a denitrification reactor, placed in communication with the first evacuation means;

third evacuation means, making it possible to extract the nitrified fumes from the denitrification reactor; and

a zone of junction between the second means for evacuation of said marginal fraction and the third means for evacuation of the denitrified fumes.

According to other characteristics of the invention:

the dust suppressing unit is of cyclonic type, and it is constituted by a cyclone or a bank of cyclones;

the zone of junction is placed in communication with an additional dust suppressor;

the additional dust suppressor is a bag filter or an electrofilter.

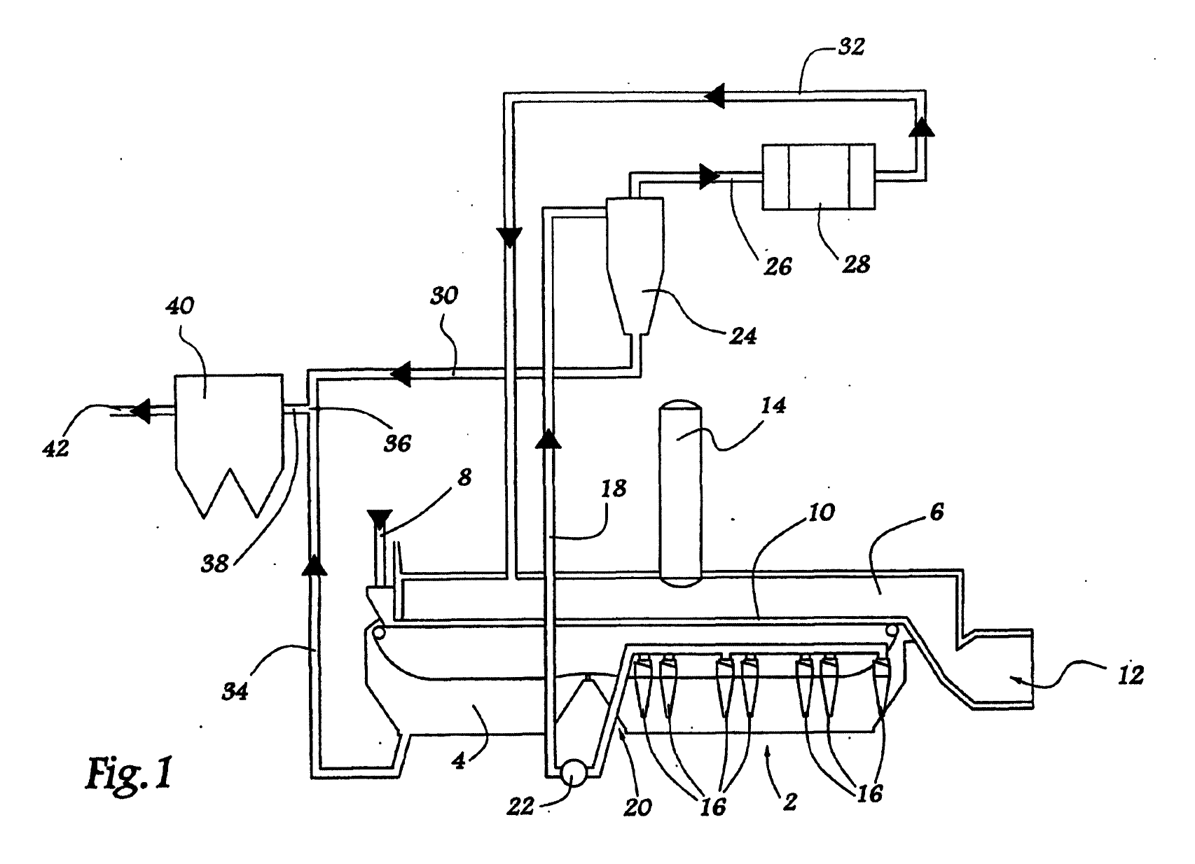

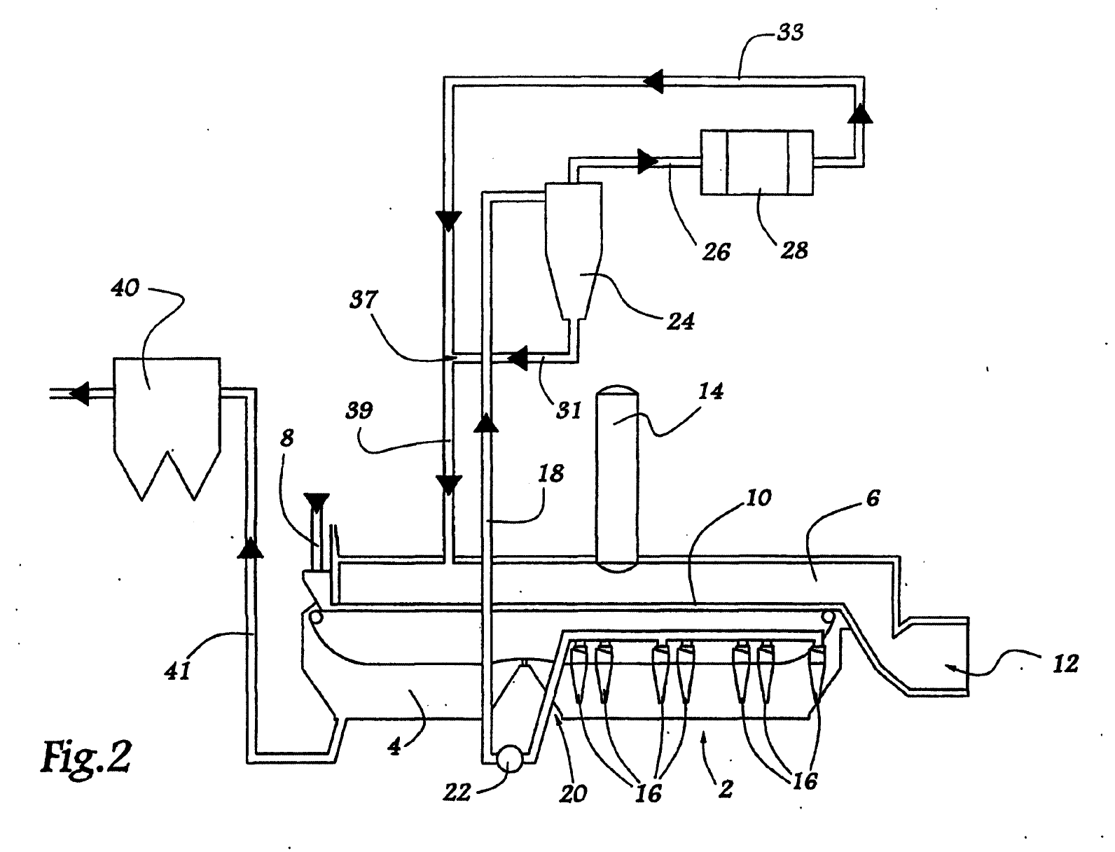

The invention will be described hereinbelow, with reference to the accompanying FIGS. 1 and 2, given solely by way of non-limiting example, which are schematic representations of two installations according to the invention for purifying cement plant fumes.

FIG. 1 shows a furnace 2, belonging to a cement manufacturing installation. This furnace, which is of “LEPOL” type, conventionally comprises a drying chamber 4 as well as a calcination chamber 6.

As is known, material intended for manufacturing the clinker is admitted via line 8, then traverses the drying chamber 4, as well as the calcination chamber 6, along a conveyor belt 10. The clinker thus obtained is then evacuated from the furnace 2 at the level of an outlet orifice 12. This furnace is also provided with a safety shaft 14.

The fumes generated inside the furnace are collected via cyclones 16, then directed in a conduit 18, extending from an intermediate zone 20 of the furnace 2. In this zone, the fumes are laden with dust, at a concentration included between 20 and 300 g/Nm³, and being at a temperature included between 250 and 400° C., particularly between 280 and 350° C.

These fumes are then extracted out of the intermediate zone 20 of the furnace 2, along the conduit 18. The latter, which is provided with a ventilator 22, is placed in communication, at its end opposite the furnace, with a dust suppressing unit 24, constituted by a cyclone or a bank of cyclones. A line 26 places this unit 24 in communication with a denitrification reactor 28. Furthermore, a conduit 30, intended for the outlet of the dust, also extends from the unit 24.

In order to stabilize the or each cyclone forming the dust suppressing unit 24, a small, or marginal, fraction of the fumes initially admitted via conduit 18, is voluntarily allowed to leave, with the underpour of each cyclone. This fraction mixed with the dust, which is evacuated through the conduit 30 with the solids collected by the dust suppressing unit 24, is included between 1 and 6% of the gaseous flow admitted into this unit 24, preferably between 2 and 4%. Furthermore, the line 26 conveys fumes cleaned of dust which contain between 100 mg/Nm³ and 5 g/Nm³ of dust, preferably between 200 mg and 1 g/Nm³.

These fumes cleaned of dust are then.directed, via the line 26, towards the denitrification reactor 28, then are evacuated therefrom, via a line 32. This latter opens out in the drying chamber 4 of the furnace 2, this allowing the denitrified fumes to be admitted into this chamber. These fumes are then extracted from the chamber 4, via a conduit 34.

The conduits 30 and 34 are then placed in mutual communication, at the level of a junction 36. This ensures the mixture between, on the one hand, the fumes collected with the dust, out of the unit 24 and, on the other hand, the fumes cleaned of dust and denitrified evacuated from the reactor 28, via the drying chamber 4.

The mixture of fumes thus constituted is then directed, via a line 38, towards a final dust suppressor 40, which is for example constituted by a filter or an electrofilter. The fumes which are extracted therefrom, via a conduit 42, then have the major part of their nitrogen oxide, as well as their dust, removed therefrom. These purified fumes are for example rejected into the atmosphere by a draught ventilator (not shown).

FIG. 2 illustrates a variant embodiment of the invention, in which the marginal fraction of fumes mixed with the dust is extracted, via a conduit 31. Furthermore, the fumes cleaned of dust, then denitrified, are evacuated from the reactor 28, via a line 33. This conduit 31 and this line 33 are placed in mutual communication, at the level of a junction 37. A line 39, which extends from this junction 37, returns into the drying chamber 4 of the furnace 2.

In this way, the denitrified fumes leaving the reactor 28 and the fumes collected with the dust, out of the unit 24, are mixed at the level of the junction 37, then returned towards the furnace 2. This mixture of fumes is then extracted from the furnace, via a line 41, and is admitted into the final dust suppressor 40.

The invention takes advantage of the extraction of the fumes, out of the furnace, at the level of an intermediate zone of the latter. Such a zone is, on the one hand, of easy access and, on the other hand, presents a temperature favourable for the treatment of the fumes via a denitrification reactor. Such a measure therefore makes it possible to dispense with the use of heat exchangers which are expensive and delicate to use, taking into account the high dust content in the fumes.

Furthermore, the fact of voluntarily evacuating a part of the fumes with the dust, by the underpour of the dust suppressing unit 24, makes it possible to increase the efficiency of the latter. Such a measure thus has the effect of reducing the dust content in the line 26 conveying the fumes cleaned of dust. This therefore guaranteees an improved protection of the catalyst contained in the denitrification reactor 28. In other words, if the extraction of the marginal fraction of fumes mixed with the dust were not provided, it would then be necessary either to replace the catalyst of the reactor 28 at too high frequencies, or to select a catalyst more resistant to dust, but of which the efficiency would be reduced.

1. Method for purifying cement plant fumes in which the fumes to be purified circulate in a furnace (2) comprising a drying chamber (4) and a calcination chamber (6), characterized in that it comprises the following steps:
extracting (through 18) the fumes to be purified out of the furnace (2), these extracted fumes being at a temperature included between 250 and 400° C.;
directing the extracted fumes towards a cyclone-type dust suppressing unit (24);
evacuating (through 26) through a first outlet of the dust suppressing unit the fumes cleaned of dust, which are denitified (in 28);
evacuating (through 30; 31) through a second outlet of the dust suppressing unit a marginal fraction of the fumes, included between 1 and 6% of the fumes input into the dust suppressing unit (24), this marginal fraction being collected at the same time as the dust; and
mixing (in 36; 37) the denitrified fumes and said marginal fraction of fumes.

2. Method according to claim 1, characterized in that the extracted fumes are at a temperature included between 280 and 350° C.

3. Method according to one of claims 1 or 2, characterized in that the marginal fraction of fumes is included between 2 and 4%, particularly 3%, of the fumes input into the dust suppressing unit (24).

4. Method according to one of claims 1 to 3, characterized in that the denitrified fumes are returned (through 32) into the drying chamber (4), these denitrified fumes are extracted (through 34) out of the furnace, then these denitrified fumes extracted from the furnace are mixed (in 36) with said marginal fraction.

5. Method according to claim 4, characterized in that the mixture of denitrified fumes and of said marginal fraction is directed (through 38) towards an additional dust suppressor (40).

6. Method according to one of claims 1 to 3, characterized in that the denitrified fumes and the marginal fraction are mixed (at 37), then the mixture of denitrified fumes and of said marginal fraction is directed (through 39) towards the drying chamber (4) of the furnace (2).

7. Installation for purifying cement plant fumes, comprising a furnace (2) belonging to a cement manufacturing installation, this furnace comprising a drying chamber (4) and a calcination chamber (6) in which the fumes to be purified circulate, in service, characterized in that it comprises:
means (18) for extracting the fumes to be purified out of the furnace, these extraction means extending from an intermediate zone (20) of said furnace having, in service, a temperature included between 250 and 400° C., preferably between 280 and 350° C.;
a dust suppressing unit (24), placed in communication with the extraction means (18);
first evacuation means (26), making it possible to extract from the dust suppressing unit the fumes cleaned of dust;
second evacuation means (30; 31), making it possible to extract from the dust suppressing unit (24) a marginal fraction of the fumes admitted into this unit, this marginal fraction being collected at the same time as dust;
a denitrification reactor (28), placed in communication with the first evacuation means (26);
third evacuation means (32; 33), making it possible to extract the nitrified fumes from the denitrification reactor; and
a zone of junction (36; 37) between the second means (30; 31) for evacuation of said marginal fraction and the third means (32; 33) for evacuation of the denitrified fumes.

8. Installation for purifying cement plant fumes according to claim 7, characterized in that the dust suppressing unit (24) is of cyclonic type, and in that it is constituted by a cyclone or a bank of cyclones;

9. Installation for purifying cement plant fumes according to one of claims 7 or 8, characterized in that the zone of junction (36; 37) is placed in communication with an additional dust suppressor (40).

10. Installation for purifying cement plant fumes according to claim 9, characterized in that the additional dust suppressor (40) is a bag filter or an electrofilter.
